(19) United States
(12) Patent Application Publication
(10) Pub. No.: US 2017/0242754 A1
(43) Pub. Date: Aug. 24, 2017

(54) SEMICONDUCTOR DEVICE

(71) Applicant: SK hynix Inc., Icheon-si Gyeonggi-do (KR)

(72) Inventors: Mun Seon JANG, Seoul (KR); Saeng Hwan KIM, Suwon-si Gyeonggi-do (KR); Bo Yeun KIM, Icheon-si Gyeonggi-do (KR)

(21) Appl. No.: 15/170,383

(22) Filed: Jun. 1, 2016

(30) Foreign Application Priority Data
Feb. 19, 2016 (KR) 10-2016-0019817

(51) Int. Cl. G06F 11/10; G06F 13/40

(52) U.S. Cl. CPC G06F 11/1096; G06F 13/4022; G06F 11/108

(57) ABSTRACT

Semiconductor device including an input and output line control circuit may be provided. The input/output line control circuit may include a write connection circuit configured to transmit data of a write local line pair based on a write control signal. The input/output line control circuit may include a connection circuit configured to transmit data received from the write connection circuit to a write segment line pair based on a switching signal. The input/output line control circuit may be configured to transmit data of the write local line pair to the write segment line pair, based on the switching signal and the write control signal.

### CROSS-REFERENCE TO RELATED APPLICATION

This application claims priority based upon Korean patent application No. 10-2016-0019817, filed on Feb. 19, 2016, the disclosure of which is hereby incorporated in its entirety by reference herein.

### BACKGROUND

1. Technical Field

Embodiments of the present disclosure generally relate to a semiconductor device, and more particularly to technology for removing data disturbance during a write operation of a semiconductor memory device.

2. Related Art

A semiconductor memory device is a memory device capable of storing data therein and reading the stored data.

Semiconductor memory devices are generally classified into a Random Access Memory (RAM) and a Read Only Memory (ROM). Data stored in the RAM is lost when its power supply is cut off, and a memory configured to store the above-mentioned data therein is referred to as a volatile memory. Data stored in the ROM does not disappear even when the power supply is cut off, and a memory capable of storing the above-mentioned data is referred to as a non-volatile memory.

The semiconductor memory device such as a DRAM from among volatile memory devices consists of a bit line sense amplifier. After a memory cell accesses the bit line sense amplifier, charge sharing between the memory cell and the bit line is achieved in the bit line sense amplifier. As a result, a small signal difference generated in the bit line is first amplified, such that the bit line sense amplifier is of importance to the semiconductor memory device.

Generally, a bit line structure of the semiconductor memory device is classified into an open bit line structure and a folded bit line structure.

The semiconductor memory device having the open bit line structure consists of a bit line extending from the bit line sense amplifier and a complementary bit line (or an inverted bit line) extending opposite to the bit line sense amplifier.

The semiconductor memory device having the folded bit line structure consists of a bit line and a complementary bit line which extend from the bit line sense amplifier. In this case, the bit line and the complementary bit line construct a pair of bit lines.

The open bit line structured semiconductor memory device consists of many more memory cells than the folded bit line structured semiconductor memory device. Therefore, the open bit line structured semiconductor memory devices have recently been widely used throughout the world.

Operations of the semiconductor memory device will hereinafter be described in detail.

A row strobe signal (/RAS) signal acting as a main signal for operating the DRAM device is activated to a low level, so that at least one row address signal is input to a row address buffer. In this case, a row decoding operation for selecting one of word lines contained in the cell array is carried out by decoding the row address signals.

In this case, the data of cells coupled to the selected word line is applied to the pair of bit lines (BL, /BL) composed of a bit line and its complementary bit line. As a result, a sense-amplifier (also called a sense-amp) enable signal indicating an operation start time of a sense amplifier is enabled to drive a sense-amp driving circuit of a cell block selected by the row address signals.

After that, sense-amp bias potentials are transitioned to a core potential (Vcore) and a ground potential (Vss) by the sense-amp driving circuit, so that the sense amplifier is driven. If the sense amplifier starts an operation, voltages of the bit lines (BL, /BL) that have maintained a slight potential difference therebetween are transitioned to have a high potential difference therebetween.

Thereafter, a column decoder turns on a column transfer transistor that transfers data from each bit line to data bus lines in response to column address signals, such that data stored in the pair of bit lines (BL, /BL) is output to the outside of the semiconductor memory device through the data bus lines (DB, /DB).

### SUMMARY

In accordance with an embodiment of the present disclosure, a semiconductor device may be provided. The semiconductor device may include a bit line sense amplifier (BLSA) configured to sense and amplify data received from a bit line pair of a cell array. The semiconductor device may include a column control circuit configured to transmit read data of the bit line pair to a read segment line pair based on a column selection signal, and transmit write data of a write segment line pair to the bit line pair. The semiconductor device may include an input/output (I/O) line control circuit configured to transmit data of the read segment line pair to a read local line pair based on a switching signal and a write control signal, and transmit data of a write local line pair to the write segment line pair.

In accordance with an embodiment of the present disclosure, a semiconductor device may be provided. The semiconductor device may include a column control circuit configured to transmit read data of a bit line pair to a read segment line pair based on a column selection signal, and transmit write data of a write segment line pair to the bit line pair. The semiconductor device may include an input/output (I/O) line control circuit configured to transmit data of the read segment line pair to a read local line pair based on a switching signal and a write control signal, and transmit data of a write local line pair to the write segment line pair. The semiconductor device may include a write control circuit configured to activate the write control signal during a write operation.

In accordance with an embodiment of the present disclosure, an input/output line control circuit may be provided. The input/output line control circuit may include a write connection circuit configured to transmit data of a write local line pair based on a write control signal. The input/output line control circuit may include a connection circuit configured to transmit data received from the write connection circuit to a write segment line pair based on a switching signal. The input/output line control circuit may be configured to transmit data of the write local line pair to the write segment line pair, based on the switching signal and the write control signal.

Wherein the equalizing circuit includes ninth, tenth, and eleventh transistors all of which are coupled together through a common gate terminal for receiving the equalizing signal, and wherein the ninth and tenth transistors are coupled in series between the pair of write segment lines.

An input and output (I/O) line control circuit comprising: a write connection circuit configured to transmit data of a write local line pair based on a write control signal; and a connection circuit configured to transmit data received from the write connection circuit to a write segment line pair based on a switching signal.

Wherein the I/O line control circuit is configured to transmit data of the write local line pair to the write segment line pair, based on the switching signal and the write control signal.

Wherein the write connection circuit only connects the pair of write local lines with the pair of write segment lines when the write control signal is activated during a write operation.

Wherein the write connection circuit includes: a first transistor coupled between a first write local line and the connection circuit to receive the write control signal through a gate terminal of the first transistor; and a second transistor coupled between a second write local line and the connection circuit to receive the write control signal through a gate terminal of the second transistor.

Wherein the connection circuit includes: a third transistor coupled between a first write segment line and the write connection circuit to receive the switching signal through a gate terminal of the third transistor; and an fourth transistor coupled between a second write segment line and the write connection circuit to receive the switching signal through a gate terminal of the fourth transistor. Wherein the input/output (I/O) line control circuit further includes: an equalizing circuit configured to equalize the write segment line pair in based on an equalizing signal.

Wherein the equalizing circuit includes fifth, sixth, and seventh transistors all of which are coupled together through a common gate terminal for receiving the equalizing signal, and wherein the fifth and sixth transistors are coupled in series between the pair of write segment lines.

### BRIEF DESCRIPTION OF THE DRAWINGS

FIG. 1 is a block diagram illustrating a representation of an example of a semiconductor device according to an embodiment of the present disclosure.

FIG. 2 is a circuit diagram illustrating a representation of an example of a bit line sense amplifier illustrated in FIG. 1.

FIG. 3 is a circuit diagram illustrating a representation of an example of a column control circuit illustrated in FIG. 1.

FIG. 4 is a circuit diagram illustrating a representation of an example of an input/output (I/O) line control circuit illustrated in FIG. 1.

FIG. 5 illustrates a block diagram of an example of a representation of a system employing a semiconductor device.

### DETAILED DESCRIPTION

Various embodiments of the present disclosure MAY BE directed to providing a semiconductor device that substantially obviates one or more problems due to limitations and disadvantages of the related art.

An embodiment of the present disclosure may relate to a technology for dividing column lines into a read-path column line and a write-path column line to overcome tCCD (CAS to CAS Delay time) limitation encountered when an Error Correction Code (ECC) circuit is used.

Reference will now be made below to the embodiments of the present disclosure, examples of which are illustrated in the accompanying drawings. Wherever possible, the same reference numbers will be used throughout the drawings to refer to the same or like parts.

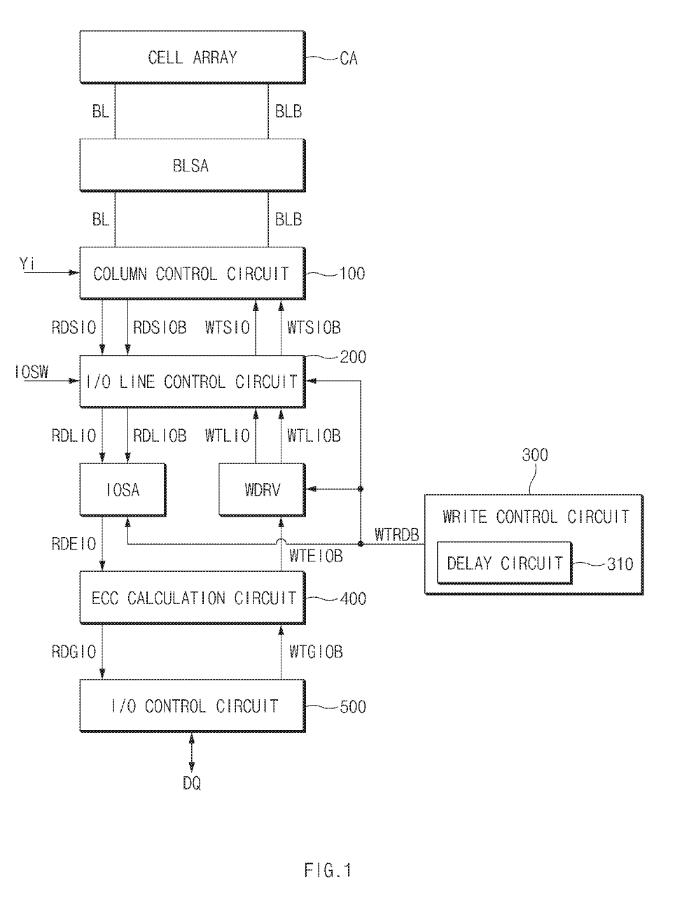

FIG. 1 is a block diagram illustrating a representation of an example of a semiconductor device according to an embodiment of the present disclosure.

Referring to FIG. 1, a semiconductor device according to an embodiment may include a cell array (CA), a bit line sense amplifier (BLSA), and a column control circuit 100. The semiconductor device according to an embodiment may include an input/output (I/O) line control circuit 200, an input/output sense amplifier (IOSA), and a write driving circuit (WDRV). The semiconductor device according to an embodiment may include a write control circuit 300, an Error Correction Code (ECC) calculation circuit 400, and an input/output (I/O) control circuit 500.

The smallest unit indicating a set (or an aggregate) of the cells of the semiconductor memory device is referred to as a cell array (CA). The cell array (CA) may include a plurality of word lines spaced apart from each other by a predetermined distance in a first direction, and a plurality of bit line pairs (BL, BLB) spaced apart from each other by a predetermined distance in a second direction perpendicular to the first direction. The cell array (CA) may read/write data from or to the cell through the pair of bit lines (BL, BLB).

The bit line sense amplifier (BLSA) may sense and amplify data received from the pair of bit lines (BL, BLB) of the cell array (CA). In this case, the BLSA may sense a voltage difference between the bit line (BL) and the complementary bit line (BLB), and may amplify the voltage difference.

The column control circuit 100 may selectively control connection among the pair of bit lines (BL, BLB), and the pair of read segment lines (RDSIO, RDSIOB), the pair of write segment lines (WTSIO, WTSIOB) in response to a column selection signal (Yi). In this case, the pair of read segment lines (RDSIO, RDSIOB) may output read data received from the column control circuit 100 to the I/O line control circuit 200. The pair of write segment lines (WTSIO, WTSIOB) may output write data received from the I/O line control circuit 200 to the column control circuit 100.

The I/O line control circuit 200 may output read data received from the pair of read segment lines (RDSIO, RDSIOB) to the pair of read local lines (RDLIO, RDLIOB) upon receiving a switching signal (IOSW) and a write control signal (WTRDB). Upon receiving the switching signal (IOSW) and the write control signal (WTRDB), the I/O line control circuit 200 may output write data received from the pair of write local lines (WTLIO, WTLIOB) to the pair of write segment lines (WTSIO, WTSIOB).

For example, if the switching signal (IOSW) is activated and the write control signal (WTRDB) is deactivated during the read operation, the I/O line control circuit 200 may output read data received from the pair of read segment lines (RDSIO, RDSIOB) to the pair of read local lines (RDLIO, RDLIOB). If the switching signal (IOSW) is activated and the write control signal (WTRDB) is activated during the write operation, the I/O line control circuit 200 may output write data received from the pair of write local lines (WTLIO, WTLIOB) to the pair of write segment lines (WTSIO, WTSIOB).

The I/O sense amplifier (IOSA) may sense and amplify read data of the pair of read local lines (RDLIO, RDLIOB) in response to the write control signal (WTRDB), and may output the amplified read data to a read line (RDEIO). A write driving circuit (WDRV) may drive write data received from the write line (WTEIOB) in response to the write control signal (WTRDB), and output the write data to the pair of write local lines (WTLIO, WTLIOB).

For example, if the write control signal (WTRDB) is deactivated during the read operation, the I/O sense amplifier (IOSA) starts operation such that read data of the pair of read local lines (RDLIO, RDLIOB) is transmitted to the read line (RDEIO). For example, if the write control signal (WTRDB) is activated during the write operation, the write driving circuit (WDRV) starts operation such that write data of the write line (WTEIOB) is applied to the pair of write local lines (WTLIO, WTLIOB).

The write control circuit 300 may generate the write control signal (WTRDB), and output the write control signal (WTRDB) to the I/O line control circuit 200, the I/O sense amplifier (IOSA), and the write driving circuit (WDRV). In this case, the write control circuit 300 may combine an I/O strobe signal for controlling the read operation, a write enable signal for controlling the write operation, etc., and may thus generate the write control signal (WTRDB).

The write control circuit 300 may include a delay circuit 310. The delay circuit 310 may delay the write control signal (WTRDB), and may output the delayed write control signal (WTRDB) to the I/O line control circuit 200.

Upon receiving read data from the read line (RDEIO), the ECC calculation circuit 400 may calculate an error correction code (ECC), and may output the calculated ECC to a read global line (RDGIO). Upon receiving write data from the write global line (WTGIOB), the ECC calculation circuit 400 generates a parity bit, and outputs the parity bit to the write line (WTEIOB).

During the read operation, the ECC calculation circuit 400 may receive not only data read from memory cells of the cell array (CA) but also the parity bit in response to an internal read command, and may detect and correct error bits generated from the read data using the parity bit and the data read from the memory cells. During the write operation, the ECC calculation circuit 400 may perform ECC encoding of write data to be stored in memory cells of the cell array (CA) in response to an internal write command, and may thus generate parity bits.

During the masked write operation, upon receiving an internal read command, the ECC calculation circuit 400 may read not only data stored in memory cells scheduled to store masked write data, but also first parity bits. The ECC calculation circuit 400 may detect and correct errors of read data using the first parity bits and the read data.

Upon receiving an internal write command, the ECC calculation circuit 400 may generate second parity bits for read data corresponding to a masked part of the masked write data from among the error correction read data and the masked write data. The ECC calculation circuit 400 may store the masked write data and the second parity bits in memory cells.

The I/O control circuit 500 may output data (DQ) to the external part in response to read data received from the read global line (RDGIO). The I/O control circuit 500 may transmit write data received from the external part to the write global line (WTGIOB).

With development of the semiconductor fabrication technology, memory capacity of semiconductor memory devices is rapidly increasing. With rapid development of the semiconductor miniaturization fabrication technology, the number of defective memory cells is also increasing.

Specifically, DRAM is a memory having finite data retention characteristics. With continuation of the DRAM fabrication scaling, a capacitance value of the cell capacitor is reduced. Accordingly, a bit error rate (BER) may increase. Defective memory cells are replaced with redundant memory cells such that the defective memory cells can be repaired. However, it may be impossible to guarantee a sufficiently high production yield (productivity) using the redundant repair scheme.

The increasing number of defective cells may reduce the production yield (productivity) of the semiconductor memory device, and it is impossible to guarantee desired memory capacity of the semiconductor memory device. As a result, various methods for increasing the production yield (productivity) of the semiconductor memory device by repairing defective cells are needed.

Therefore, the memory device may relieve error bits using the ECC circuit. The ECC algorithm provides the ECC function capable of detecting errors encountered in the process of writing and reading data and at the same time automatically correcting the detected errors.

That is, the ECC (Error Checking and Correction) circuit for checking/correcting errors of data stored in the memory device is used. The ECC circuit may check errors of data on the basis of the data and parity bits, such that it can correct erroneous data when the erroneous data occurs.

The memory device may perform a masked write operation during the write operation, such that data is not written in some parts of memory cell blocks constructing the memory cell array during the write operation.

During the masked write operation, legacy data is retained in some parts of the memory cell blocks in which no data is written, and new data is written in the remaining memory cell blocks. A first operation for reading legacy data, a second operation for modifying parity bits by applying the ECC circuit to the legacy data and new data, and a third operation for writing the new data and the modified parity bits are of importance to the masked write operation. A memory device capable of safely performing the masked write operation is needed.

That is, assuming that the masked write operation is performed when the ECC circuit is used, legacy data is read from memory cells scheduled to store the masked write data therein, parity bits for legacy data and the masked write data are modified, and a specific operation (Read-Modify-Write (RMW) operation) for writing the masked write data and the modified parity bits is performed.

After completion of the Read-Modify-Write (RMW) operation, the masked write operation performs ECC calculation. Accordingly, a specific time (tCCD+a) in which the read and write operations can be performed, instead of a general tCCD (CAS to CAS Delay) time, is needed. Therefore, it is difficult to properly cope with the RMW operation according to a general tCCD (CAS to CAS Delay) time.

If a read path and a write path of column lines are not separated from each other as in the conventional art, the tCCD (CAS to CAS Delay) time indicating a predetermined time elapsed from a first time at which the write signal is enabled may be delayed. That is, after the semiconductor device receives a normal write command or a masked write command, the tCCD timing limitation may occur in the semiconductor device until the semiconductor device receives a subsequent write command.

As a result, the semiconductor device according to an embodiment divides column lines into a read-path column line and a write-path column line, such that the semiconductor device can obviate the tCCD margin limitation encountered when the ECC circuit is used.

The semiconductor device according to an embodiment can use a single global column line, and at the same time can separate each of the read path and the write path from the bit line sense amplifier (BLSA) circuit. Accordingly, the semiconductor device according to an embodiment can be free from tCCD specification during the read operation, resulting in prevention of data disturbance.

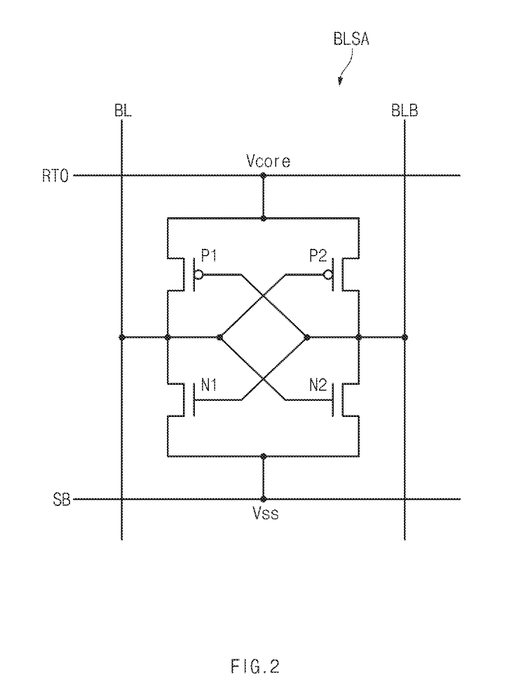

FIG. 2 is a circuit diagram illustrating a representation of an example of the bit line sense amplifier (BLSA) illustrated in FIG. 1.

Referring to FIG. 2, the bit line sense amplifier (BLSA) may include PMOS transistors (P1, P2) and NMOS transistors (N1, N2) to sense/amplify data received from the pair of bit lines (BL, BLB) of the cell array (CA).

The BLSA may receive, for example, a core voltage (Vcore) through a power-supply line (RTO), and may receive a ground voltage (VSS) through a power-supply line (SB). The PMOS transistor (P1) and the NMOS transistor (N1) are coupled in series between the power-supply line (RTO) and the other power-supply line (SB), such that a common gate terminal is coupled to the upper bit line (BLB).

The PMOS transistor (P2) and the NMOS transistor (N2) are coupled in series between the power-supply line (RTO) and the other power-supply line (SB), such that a common gate terminal is coupled to the bit line (BL).

Upon receiving a power-supply signal from the power-supply lines (RTO, SB), the bit line sense amplifier (BLSA) may detect and amplify data received from the pair of bit lines (BL, BLB) of the cell array (CA).

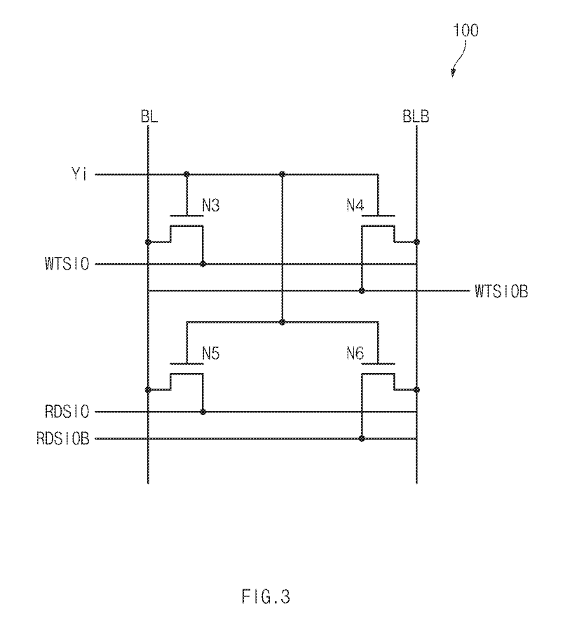

FIG. 3 is a circuit diagram illustrating a representation of an example of the column control circuit 100 illustrated in FIG. 1.

Referring to FIG. 3, the column control circuit 100 may selectively control connection among the bit line pair (BL, BLB), the read segment line pair (RDSIO, RDSIOB), and the write segment line pair (WTSIO, WTSIOB) in response to a column selection signal (Yi).

The column control circuit 100 may include NMOS transistors (N3, N4) acting as the write switching circuit and other NMOS transistors (N5, N6) acting as the read switching circuit. Here, the NMOS transistors (N3˜N6) may receive the column selection signal (Yi) through a common gate terminal.

The NMOS transistor N3 is coupled between the bit line (BL) and the write segment line (WTSIO), and thus receives the column selection signal (Yi) through a gate terminal thereof. The NMOS transistor N4 is coupled between the complementary bit line (BLB) and the write segment line (WTSIOB), and thus receives the column selection signal (Yi) through a gate terminal thereof.

The NMOS transistor N5 is coupled between the bit line (BL) and the read segment line (RDSIO), and thus receives a column selection signal (Yi) through a gate terminal thereof. The NMOS transistor N6 is coupled between the complementary bit line (BLB) and the read segment line (RDSIOB), and thus receives the column selection signal (Yi) through a gate terminal thereof.

If the column selection signal (Yi) is activated to a high level, the NMOS transistors (N3˜N6) of the column control circuit 100 are turned on. Therefore, the pair of bit lines (BL, BLB) is connected to the pair of read segment lines (RDSIO, RDSIOB), and the pair of bit lines (BL, BLB) is connected to the pair of write segment lines (WTSIO, WTSIOB).

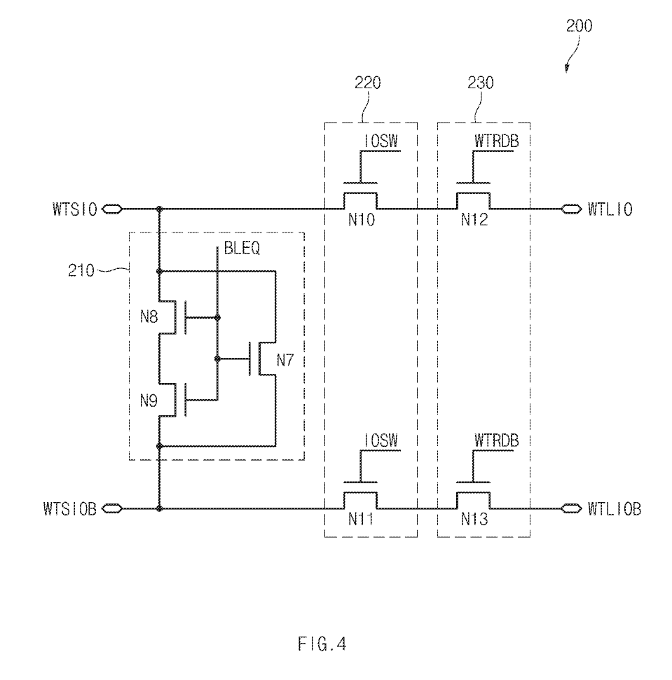

FIG. 4 is a circuit diagram illustrating a representation of an example of the input/output (I/O) line control circuit 200 illustrated in FIG. 1.

Referring to FIG. 4, when the switching signal (IOSW) and the write control signal (WTRDB) are activated, the I/O line control circuit 200 may output write data received from the pair of write local lines (WTLIO, WTLIOB) to the pair of write segment lines (WTSIO, WTSIOB).

The I/O line control circuit 200 may include an equalizing circuit 210, a connection circuit 220, and a write connection circuit 230.

The equalizing circuit 210 may equalize the pair of write segment lines (WTSIO, WTSIOB) when the equalizing signal (BLEQ) is activated. The equalizing circuit 210 may include a plurality of NMOS transistors (N7˜N9).

The NMOS transistors (N7˜N9) may receive the equalizing signal (BLEQ) through a common gate terminal. The NMOS transistor N7 may be coupled between the write segment lines (WTSIO, WTSIOB). The NMOS transistors (N8, N9) may be coupled in series between the write segment lines (WTSIO, WTSIOB).

When the switching signal (IOSW) is activated, the connection circuit 220 may transmit data of the pair of write local lines (WTLIO, WTLIOB) to the pair of write segment lines (WTSIO, WTSIOB). The connection circuit 220 may include NMOS transistors (N10, N11).

The NMOS transistor N10 is coupled between the write segment line (WTSIO) and the write connection circuit 230, and thus receives the switching signal (IOSW) through a gate terminal thereof. The NMOS transistor N11 is coupled between the write segment line (WTSIOB) and the write connection circuit 230, and thus receives the switching signal (IOSW) through a gate terminal thereof.

When the write control signal (WTRDB) is activated, the write connection circuit 230 may transmit data of the pair of write local lines (WTLIO, WTLIOB) to the connection circuit 220. The write connection circuit 230 may include NMOS transistors (N12, N13).

The NMOS transistor N12 is coupled between the write local line (WTLIO) and the NMOS transistor N10, and thus receives the write control signal (WTRDB) through a gate terminal thereof. The NMOS transistor N13 is coupled between the write local line (WTLIOB) and the NMOS transistor N11, and thus receives the write control signal (WTRDB) through a gate terminal thereof.

If the switching signal (IOSW) is activated to a high level, the NMOS transistors (N10, N11) of the connection circuit 220 are turned on. When the write control signal (WTRDB) is activated, NMOS transistors (N12, N13) of the write connection circuit 230 are turned on. As a result, the pair of write local lines (WTLIO, WTLIOB) are coupled to the pair of write segment lines (WTSIO, WTSIOB).

In this case, collision between read data and write data may occur in the read operation. Therefore, the write connection circuit 230 contained in the I/O line control circuit 200 starts operation only when the write control signal (WTRDB) is activated during the write operation, such that the pair of write local lines (WTLIO, WTLIOB) are connected to the pair of write segment lines (WTSIO, WTSIOB). That is, the write control signal (WTRDB) is deactivated during the read operation, such that data disturbance caused by the write path can be removed.

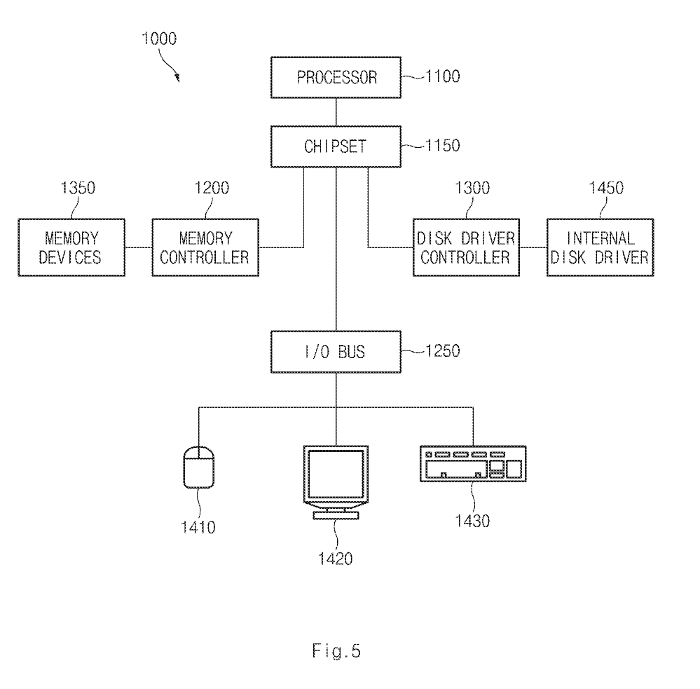

The semiconductor device as discussed above (see FIGS. 1-4) are particular useful in the design of memory devices, processors, and computer systems. For example, referring to FIG. 5, a block diagram of a system employing a semiconductor device in accordance with the various embodiments are illustrated and generally designated by a reference numeral 1000. The system 1000 may include one or more processors (i.e., Processor) or, for example but not limited to, central processing units (“CPUs”) 1100. The processor (i.e., CPU) 1100 may be used individually or in combination with other processors (i.e., CPUs). While the processor (i.e., CPU) 1100 will be referred to primarily in the singular, it will be understood by those skilled in the art that a system 1000 with any number of physical or logical processors (i.e., CPUs) may be implemented.

A chipset 1150 may be operably coupled to the processor (i.e., CPU) 1100. The chipset 1150 is a communication pathway for signals between the processor (i.e., CPU) 1100 and other components of the system 1000. Other components of the system 1000 may include a memory controller 1200, an input/output (“I/O”) bus 1250, and a disk driver controller 1300. Depending on the configuration of the system 1000, any one of a number of different signals may be transmitted through the chipset 1150, and those skilled in the art will appreciate that the routing of the signals throughout the system 1000 can be readily adjusted without changing the underlying nature of the system 1000.

As stated above, the memory controller 1200 may be operably coupled to the chipset 1150. The memory controller 1200 may include at least one semiconductor device as discussed above with reference to FIGS. 1-4. Thus, the memory controller 1200 can receive a request provided from the processor (i.e., CPU) 1100, through the chipset 1150. In alternate embodiments, the memory controller 1200 may be integrated into the chipset 1150. The memory controller 1200 may be operably coupled to one or more memory devices 1350. In an embodiment, the memory devices 1350 may include the at least one smart self-repair device and/or method of self-repairing a package as discussed above with relation to FIGS. 1-4, the memory devices 1350 may include a plurality of word lines and a plurality of bit lines for defining a plurality of memory cells. The memory devices 1350 may be any one of a number of industry standard memory types, including but not limited to, single inline memory modules (“SIMMs”) and dual inline memory modules (“DIMMs”). Further, the memory devices 1350 may facilitate the safe removal of the external data storage devices by storing both instructions and data.

The chipset 1150 may also be coupled to the I/O bus 1250. The I/O bus 1250 may serve as a communication pathway for signals from the chipset 1150 to I/O devices 1410, 1420, and 1430. The I/O devices 1410, 1420, and 1430 may include, for example but are not limited to, a mouse 1410, a video display 1420, or a keyboard 1430. The I/O bus 1250 may employ any one of a number of communications protocols to communicate with the I/O devices 1410, 1420, and 1430. In an embodiment, the I/O bus 1250 may be integrated into the chipset 1150.

The disk driver controller 1300 may be operably coupled to the chipset 1150. The disk driver controller 1300 may serve as the communication pathway between the chipset 1150 and one internal disk driver 1450 or more than one internal disk driver 1450. The internal disk driver 1450 may facilitate disconnection of the external data storage devices by storing both instructions and data. The disk driver controller 1300 and the internal disk driver 1450 may communicate with each other or with the chipset 1150 using virtually any type of communication protocol, including, for example but not limited to, all of those mentioned above with regard to the I/O bus 1250.

It is important to note that the system 1000 described above in relation to FIG. 5 is merely one example of a system 1000 employing a semiconductor device as discussed above with relation to FIGS. 1-4. In alternate embodiments, such as, for example but not limited to, cellular phones or digital cameras, the components may differ from the embodiments illustrated in FIG. 5.

As is apparent from the above description, after completion of the ECC (Error Correction Code) operation of the semiconductor memory device, the semiconductor device according to embodiments can remove data disturbance during the write operation.

Those skilled in the art will appreciate that the embodiments may be carried out in other specific ways than those set forth herein without departing from the spirit and essential characteristics of the descriptions. The above embodiments are therefore to be construed in all aspects as illustrative and not restrictive. The scope should be determined by the appended claims and their legal equivalents, not by the above description. Further, all changes coming within the meaning and equivalency range of the appended claims are intended to be embraced therein. In addition, it is obvious to those skilled in the art that claims that are not explicitly cited in each other in the appended claims may be presented in combination as an embodiment or included as a new claim by a subsequent amendment after the application is filed.

Although a number of illustrative embodiments consistent with the description have been described, it should be understood that numerous other modifications and embodiments can be devised by those skilled in the art that will fall within the spirit and scope of the principles of this disclosure. Particularly, numerous variations and modifications are possible in the component parts and/or arrangements which are within the scope of the disclosure, the drawings and the accompanying claims. In addition to variations and modifications in the component parts and/or arrangements, alternative uses will also be apparent to those skilled in the art.

What is claimed is:

1. A semiconductor device comprising:
a bit line sense amplifier (BLSA) configured to sense and amplify data received from a bit line pair of a cell array;
a column control circuit configured to transmit read data of the bit line pair to a read segment line pair based on a column selection signal, and transmit write data of a write segment line pair to the bit line pair; and
an input/output (I/O) line control circuit configured to transmit data of the read segment line pair to a read local line pair, and transmit data of a write local line pair to the write segment line pair, upon receiving a switching signal and a write control signal.

2. The semiconductor device according to claim 1, wherein the column control circuit includes:
a read switching circuit configured to transmit read data of the bit line pair to the read segment line pair based on the column selection signal, during a read operation; and
a write switching circuit configured to transmit write data of the write segment line pair to the bit line pair based on the column selection signal, during a write operation.

3. The semiconductor device according to claim 2, wherein the read switching circuit includes:
a first transistor coupled between a bit line and a first read segment line, configured to receive the column selection signal through a gate terminal of the first transistor; and
a second transistor coupled between a complementary bit line and a second read segment line, configured to receive the column selection signal through a gate terminal of the second transistor.

4. The semiconductor device according to claim 2, wherein the write switching circuit includes:
a third transistor coupled between a bit line and a first write segment line, configured to receive the column selection signal through a gate terminal of the third transistor; and
a fourth transistor coupled between a complementary bit line and a second write segment line, configured to receive the column selection signal through a gate terminal of the fourth transistor.

5. The semiconductor device according to claim 1, wherein the input/output (I/O) line control circuit, when the switching signal and the write control signal are activated during a write operation, transmits data of the write local line pair to the write segment line pair.

6. The semiconductor device according to claim 1, wherein the input/output (I/O) line control circuit includes:
a write connection circuit configured to transmit data of the write local line pair based on the write control signal; and
a connection circuit configured to transmit data received from the write connection circuit to the write segment line pair based on the switching signal.

7. The semiconductor device according to claim 6, wherein the write connection circuit includes:
a fifth transistor coupled between a first write local line and the connection circuit to receive the write control signal through a gate terminal of the fifth transistor; and
a sixth transistor coupled between a second write local line and the connection circuit to receive the write control signal through a gate terminal of the sixth transistor.

8. The semiconductor device according to claim 6, wherein the connection circuit includes:
a seventh transistor coupled between a first write segment line and the write connection circuit to receive the switching signal through a gate terminal of the seventh transistor; and
an eighth transistor coupled between a second write segment line and the write connection circuit to receive the switching signal through a gate terminal of the eighth transistor.

9. The semiconductor device according to claim 6, wherein the input/output (I/O) line control circuit further includes:
an equalizing circuit configured to equalize the write segment line pair based on an equalizing signal.

10. The semiconductor device according to claim 1, further comprising:
an input/output (I/O) sense amplifier configured to sense and amplify data of the read local line pair based on the write control signal during a read operation, and output the amplified data to a read line.

11. The semiconductor device according to claim 10, further comprising:
a write driving circuit configured to transmit write data received from a write line to the write local line pair based on the write control signal, during a write operation.

12. The semiconductor device according to claim 11, further comprising:
an error correction code (ECC) calculation circuit configured to read data of the read line, perform ECC calculation on the read data, and transmit a parity bit to the cell array through the write line.

13. The semiconductor device according to claim 12, further comprising:
an input/output (I/O) control circuit configured to receive data of the ECC calculation circuit through a read global line, output the received data to an external part, receive external data, transmit the received external data to the ECC calculation circuit through a write global line.

14. The semiconductor device according to claim 1, further comprising:
a write control circuit configured to activate the write control signal during a write operation.

15. The semiconductor device according to claim 14, wherein the write control circuit further includes:
a delay circuit configured to delay the write control signal, and output the delayed write control signal to the input/output (I/O) line control circuit.

16. A semiconductor device comprising:
a column control circuit configured to transmit read data of a bit line pair to a read segment line pair based on a column selection signal, and transmit write data of a write segment line pair to the bit line pair; and
an input/output (I/O) line control circuit configured to transmit data of the read segment line pair to a read local line pair based on a switching signal and a write control signal, and transmit data of a write local line pair to the write segment line pair; and
a write control circuit configured to activate the write control signal during a write operation.

17. The semiconductor device according to claim 16, further comprising:
an input/output (I/O) sense amplifier configured to sense and amplify data of the read local line pair based on the write control signal during a read operation, and output the amplified data to a read line.

18. The semiconductor device according to claim 17, further comprising:
a write driving circuit configured to transmit write data received from a write line to the write local line pair based on the write control signal, during a write operation.

19. The semiconductor device according to claim 18, further comprising:
an error correction code (ECC) calculation circuit configured to read data of the read line, perform ECC calculation on the read data, and transmit a parity bit through the write line.

20. The semiconductor device according to claim 19, further comprising:
an input/output (I/O) control circuit configured to receive data of the ECC calculation circuit through a read global line, output the received data to an external part, receive external data, transmit the received external data to the ECC calculation circuit through a write global line.
